(19) United States
(12) Patent Application Publication
(10) Pub. No.: US 2014/0016487 A1
(43) Pub. Date: Jan. 16, 2014

(54) TEST SYSTEM TO ESTIMATE THE UPLINK OR DOWNLINK QUALITY OF MULTIPLE USER DEVICES USING A MEAN OPINION SCORE (MOS)

(71) Applicant: Jheroen Pieter Dorenbosch, Paradise, TX (US)

(72) Inventor: Jheroen Pieter Dorenbosch, Paradise, TX (US)

(73) Assignee: ANRITSU COMPANY, Morgan Hill, CA (US)

(21) Appl. No.: 13/549,266

(22) Filed: Jul. 13, 2012

(51) Int. Cl. H04W 24/00

(52) U.S. Cl. 370/252

(57) ABSTRACT

A test system is provided to test both voice and video quality of the connection for a large number of mobile phones, tablets, laptops or other user transmit/receive devices from a central location. The quality can be expressed as a Mean Opinion Score (MOS) and the uplink and downlink connection quality can be separately estimated. The system allows the use of media fragments that are characteristic of an end user and allows video data to be measured at the time and location that the user typically makes calls.

### BACKGROUND

1. Technical Field

The present invention relates to a configuration of a test system to evaluate impairments, including losses, errors, noise and jitter, in a network wireless communication signal to enable estimation of degradation in voice or video quality.

2. Related Art

Several test system configurations exist to estimate the quality of uplink and downlink media connections or uplink and downlink media links of networked devices, the network devices including fixed, nomadic and mobile phones, tablets, notebooks, laptops and computers. The systems provide estimates for speech and/or video. The connections tested may be dedicated circuit-switched connections or may be Voice over IP (VoIP). Existing test methods may base the estimate of quality on information about connection characteristics, such as delay, packet loss and jitter. An example of a system that uses this type of estimation is the Anritsu CMA 3000 All-In-One Field Tester for Fixed and Mobile Networks.

These conventional methods base the estimate on a comparison of speech or video media before and after the media have been passed through the test system from a sending user to a receiving user. An example of a system that uses this type of estimation is the Anritsu ME7834 Mobile Device Test Platform. This platform emulates a wireless network and an air interface to provide realistic testing of advanced mobile User Equipment (UE).

In a conventional test system shown in FIG. 1, the Device Under Test (DUT) is directly connected to the Test System (TS). In such a system it is possible to estimate the media quality of a combination of the downlink media link or downlink connection (from the TS towards the DUT) and the uplink media link or uplink connection (from the DUT to the TS). For example, to estimate media quality the test system 2 takes a reference media sample or “reference” media file 1 and plays the sample over either a real or emulated wireless system 4. The reference media sample 1 may suffer many different impairments, such as encoding & decoding by codecs, loss of dynamic range, fading, delay, jitter, packet loss, errored bits, losses in de-randomizing buffers, and the addition of noise at the input and output. All of these impairments conspire to decrease the quality of the received media. To estimate the effect, the media is captured at the DUT UE 6 and placed in what is traditionally called a “degraded” media sample or a “degraded file” 8. The conventional test system had access to both the reference media sample 1 and the degraded sample 8 and compares them to estimate the effect of the impairments.

To make the comparison, typically speech or video degradation was estimated by a group of people who listen to the speech or look at videos to form their opinion about the quality. The people rated the quality on a scale of 1 to 5 and the average of the scores was calculated to get a Mean Opinion Score (MOS). Currently, standardized software and algorithms are available to derive the MOS. Example software tools are PESQ—which stands for “Perceptual Evaluation of Speech Quality” (standardized by ITU-T Recommendation P.862); POLQA—which stands for “Perceptual Objective Listening Quality Analysis” (standardized by ITU-T Recommendation P.863); PEVQ—which stands for “Perceptual Evaluation of Video Quality”, the Peak-Signal-to-Noise-Ratio (PSNR) algorithm; and the structural similarity (SSIM) algorithm.

In addition to testing speech and video quality in the laboratory, operators and equipment vendors also want to test the media quality in the field, preferably using a large number of UEs at a wide variety of locations. Media quality testing in the field is much harder, because it is non-trivial to access both the Reference Media and the Degraded Media at a single location. Several topologies have been used, and a few examples are given below.

FIG. 2 shows how a test system can be arranged evaluate the MOS for a UE that is in the field. In the system connection of FIG. 2, the UE 6 is programmed to loop-back any audio that it receives on the downlink. This way the test system 2 can play a reference media sample 1, transmit it to the UE 6 and capture the corresponding degraded media sample 8. A disadvantage of this method is that the media passes over both the downlink and the uplink before it is captured, and the MOS evaluation only reflects the combined effect of the two. Another disadvantage is that the method is intrusive for the end-user operating the UE 6, because the end-user cannot make calls from the UE 6 while media quality tests are in progress. For convenience components in FIG. 1 that are carried over to FIG. 2 are similarly labeled as will be components carried over in subsequent figures.

FIG. 3 shows another example of how a test system configuration set to evaluate the MOS for a UE that is in the field. In this example, the test system 2 is a laptop that is tethered to or more UEs 6₁-6₂. To test UEs 6₁-6₂ in the field, the laptop test system 2 also has to be in the field. The laptop TS 2 commands a first one of the tethered UEs 6₁ to call a second tethered UE 6₂. Once the call is established, the TS 2 makes the first UE 6₁ play a reference media sample 1 to the second UE 6₂ through the wireless system 4 and obtains the corresponding degraded media sample 8 from the second UE 6₂. The TS 2 can then compute the MOS. This test system has the same disadvantages that the MOS only reflects the combined effect of the downlink and the uplink and that the UEs cannot be used while media quality tests are in progress. Moreover, in this topology a single test system can only test a limited number of UE connections, and since each test system needs a separate license for the media quality evaluation software, this test system method is expensive.

It is well known that reference media files provided by subjects with different dialects or speech patterns can produce rather different MOS values. Apparently the MOS depends on subtle properties of the subjects used to generate the reference files. Thus, there always is a possibility that the MOS that is measured for one user does not correspond to the MOS measured for a user with a slightly different speech pattern, dialect or intonation.

### SUMMARY

Embodiments of the present invention provide a test system to test the quality of the voice and video connection of a large number of mobile phones or laptops from a central location. The quality can be expressed as a MOS and the uplink and downlink connection or link can be separately estimated. The system allows both audio speech phonemes that are characteristic of the end user and video data that are characteristic of the end user to be measured at the time that the user typically makes calls.

Embodiments of the present invention in particular provides one or more of the following features:

(1) The test system provides independent measurements of the quality of the downlink media link and the uplink media link.

(2) The MOS values determined by the test system are determined at times and locations that are representative for the times and locations where the user typically makes calls.

(3) A test system that is provided with a single license for media quality evaluation can evaluate the media quality for a large number of UEs.

(4) The user equipment (UE) for which the link quality is measured, which includes an end-user's own cell phone, tablet computer, or other transmission/reception device, only requires a minimal amount of modifications and remains fully available to the end-user.

(5) The system executes an evaluation with a minimal amount of time to reduce the impact on the end-users.

(6) The MOS values provided by the system can be determined from a wide variety of reference files, and the reference files can be representative of the language and speech patterns of the end-user and the people with whom the end-user communicates.

### BRIEF DESCRIPTION OF THE DRAWINGS

Further details of the present invention are explained with the help of the attached drawings in which:

FIG. 1 illustrates the classic test system to measure voice quality in a wireless system;

FIG. 2 shows a method for estimating MOS for a UE in the field using loop-back;

FIG. 3 shows a method for estimating MOS for a UE in the field using tethered UEs;

FIG. 4 provides a test system configuration overview for gathering MOS values for a large number of UEs in the field;

FIG. 5 provides a connectivity diagram for an embodiment of the present invention that will be referenced for evaluation of downlink and uplink media link quality as part of a call;

FIG. 6 is a connectivity diagram showing embodiments to minimize impact on an end-user;

FIG. 7 illustrates evaluation of downlink and uplink media link quality as part of a session; and

FIG. 8 illustrates obtaining and using user-specific media samples.

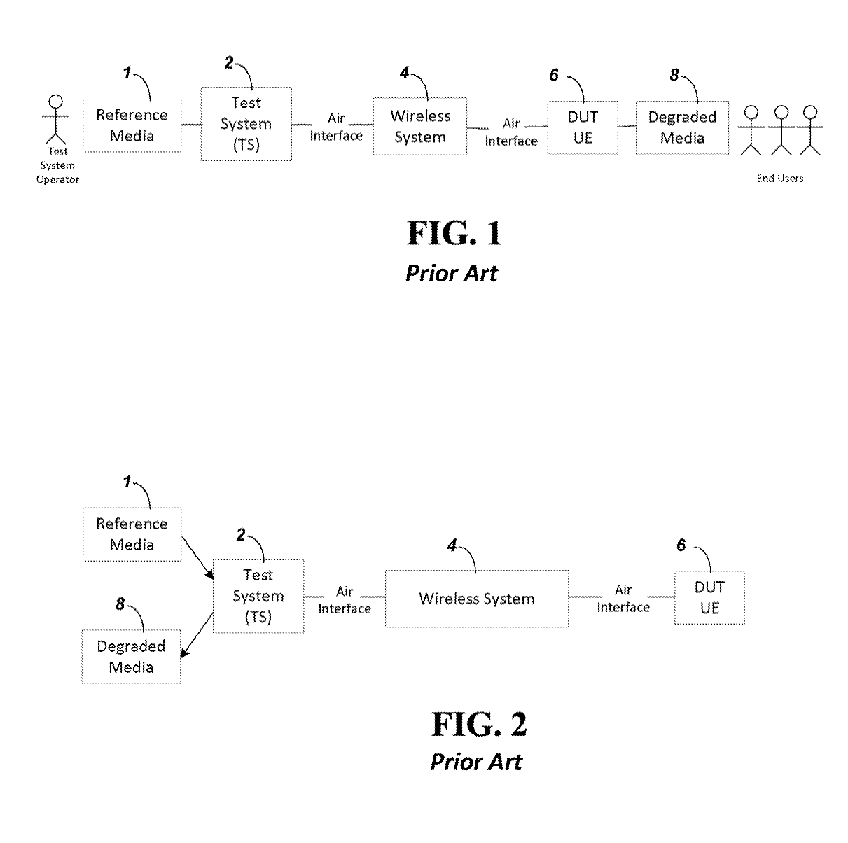

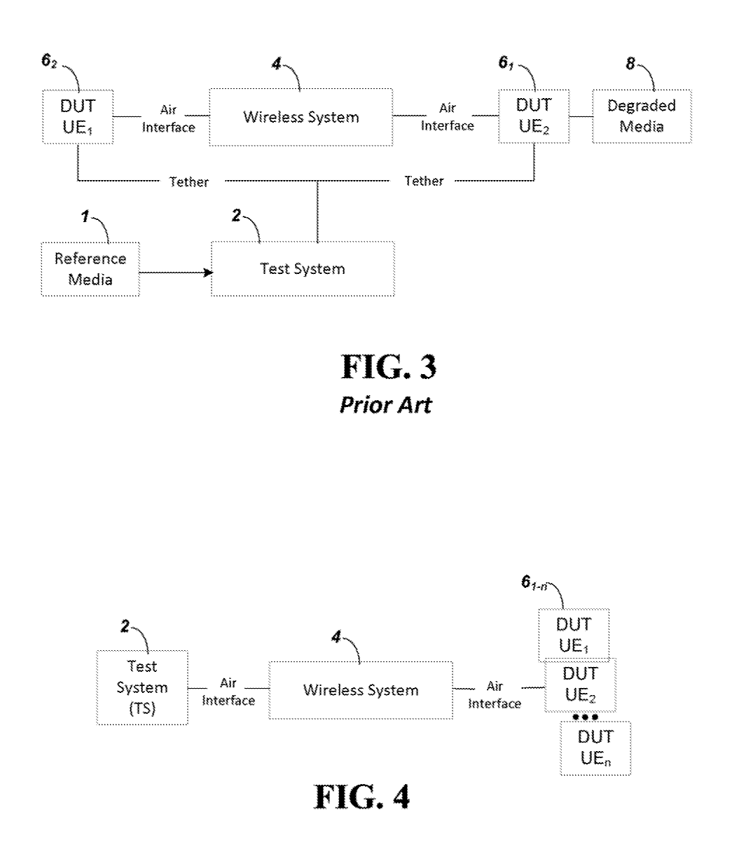

### DETAILED DESCRIPTION

### System Overview

FIG. 4 provides a test system configuration overview using a test system (TS) 2 for gathering MOS values for a large number of DUT UEs 6₁-6ₙ in the field according to embodiments of the present invention. The test system is coupled to a fixed portion of a Wireless System 4 or a similar fixed communication network. The Wireless System 4 can be one of many types including a 3G or 4G system, such as a UMTS, CDMA or LET system that can support voice calls, packet data and optionally video calls.

The coupling between the TS 2 and Wireless System 4 can be very tight, as in a solution where the TS communicates directly with infrastructure elements like a Packet Data Gateway (PDG) and a Policy and Charging Rules Function (PCRF). The PDG provides packet data access to the UE, which in turn allows for the setup of data bearers for calls and for the downloading and uploading of data files. The connection to the PCRF allows the TS to get the necessary Quality of Service (QoS) for these data bearers.

The coupling between the TS 2 and the Wireless System 4 can also be rather loose. For example, the TS can be an Application Server in an IMS system and communicate with the Wireless System 4 via a Serving-Call Session Control Function (CSCF) and a Proxy-CSCF. In this case the TS 2 can still obtain the necessary QoS by communicating with the PCRF via the P-CSCF. The setup of the calls and packet data connections can use the Session Initiation Protocol (SIP) but may also use other methods.

Note that FIG. 4 shows a wireless system 4. However, embodiments of the present invention may be used in any type of wired and wireless communication system that supports voice or video calls. As will become clear below, many of the embodiments do not rely on the detailed operation of the communication system, as long as the TS 2 and DUT or UEs 6₁-6ₙ can establish calls and make packet data connections. The UEs may be cellular phones, such as iPhones, Android phones or Blackberry phones, Wi-Fi-connected devices, SIP phones, laptops or PCs, or computers that make calls using public phone systems, cellular systems or internet-based services like Skype.

### Test-Call Embodiment for Uplink Link Quality Evaluation

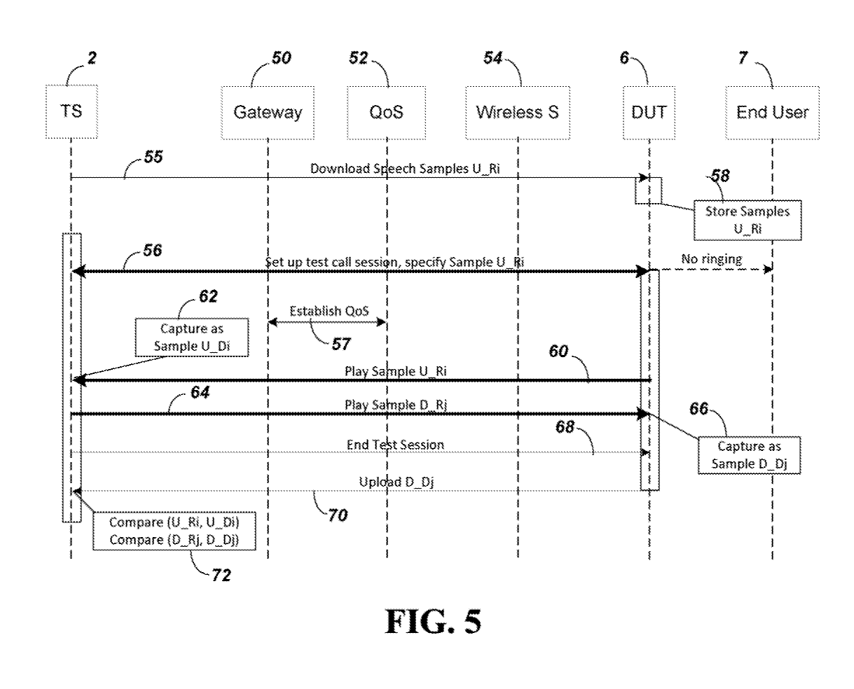

FIG. 5 provides a connectivity diagram for an embodiment of the present invention that will be referenced for evaluation of downlink and uplink media link quality as part of a call. For FIG. 5, the Test Station (TS) 2 is provisioned with at least one media sample. The media sample may be a high quality voice sample, a high quality video sample or a sample that contains a combination of voice and video. A useful media sample could last from a few seconds to a few minutes. In the context of the present invention, video may also consists of a sequence of one or more still pictures, each encoded, for example, as jpeg data. The TS 2 typically is provisioned with many such samples and will use many different samples to test the media quality for a DUT UE 6. This is done to take out the dependence on the properties of individual samples by averaging the quality ratings over a number of different samples. Media samples typically are stored as files on a hard drive or in non-volatile RAM, but may also be kept in normal Random Access Memory.

For FIG. 5, we assume the UE DUT 6 has been programmed to implement the embodiment. The end-user 7 of the DUT 6 could be given a small compensation for participating in media link quality testing. The final reward for the end-user 7 will be that the system quality will be better understood, which will lead to better overall connectivity.

For FIG. 5, the media link quality of the uplink, or uplink quality (from the DUT 6 to the TS 2) is measured independently from the link quality of the downlink, or downlink quality (from the TS 2 to the DUT 6). In fact, certain implementations may measure only the uplink link quality or only the downlink link quality. This is true for all embodiments in this disclosure, but for expedience FIG. 5 shows combined measurements of uplink and downlink MOS, as this will be the most likely implementation.

Further for FIG. 5, as well as subsequent figures, some internal software components of the wireless system 4 (of FIG. 4) are illustrated. The wireless system components include a gateway 50, a Quality of Service (QoS) determination module 52, and a wireless system transceiver 54. Uplink and Downlink connections using these wireless system components will be described subsequently. To measure the media quality of the uplink of a DUT 6 in FIG. 5, one or more media samples are selected and transferred between the TS 2 and the DUT 6. In particular, for the embodiment presented in this Figure, the TS 2 selects the one or more media samples and downloads them to the DUT 6 as illustrated by line 55. In this disclosure, the terms ‘download’ and ‘upload’ refer to download and upload procedures that reliably transport data on a downlink or an uplink such that error-free reception can be ascertained by the sender. The received data will be an exact copy of the data that was sent, and is not affected by impairments. This can be done using well-known procedures such as the Transport Control Protocol (TCP), the File Transport Protocol (FTP) and Secure FTP (SFTP). The TS 2 retains a copy of each file it downloads to the DUT 6. Note that any uploading and downloading can proceed with low Quality of Service QoS (e.g. ‘Best Effort’) and thus is inexpensive and does not interfere noticeably with the activities of the end-user 7.

The DUT 6 is programmed to store each downloaded file in such a way that it can later be retrieved. When multiple files are downloaded, the files are indexed or named such that a specific file can later be specified and selected. The downloaded samples are referenced as “U_R”, because they will be used by the TS 2 and the DUT 6 as the Uplink Reference sample. Storage of the sample U_Ri in the DUT is illustrated by box 58.

To start a test session, the Test System 2 initiates a call to the DUT 6 as illustrated by line 56. The call setup can be fully conventional, and no special provisions are needed in the communication system to establish the call. As part of the conventional call setup the communication system will establish uplink and downlink connections or bearers for the call that have the Quality of Service necessary to support the transmission of voice and/or video, as appropriate for the call that is being set up. Establishing the QoS is illustrated by line 57. Typically the QoS is established automatically as part of the call setup procedure. For example, the Gateway 50 or a Proxy-CSCF may request the QoS for the call via a PCRF 52.

The DUT 6 is programmed to recognize the call as belonging to a test session. The DUT 6 may do this by recognizing the caller-ID for the call as the ID of the TS 2. Alternatively, if SIP is used for call setup, there may be test-session-identifying information in one of the call setup messages for example in a SIP message header or in a SIP message body. When a DUT 6 recognizes the call as belonging to a test session, the DUT 6 preferably auto-answers the call. It suppresses all notifications to the end-user; i.e. the DUT 6 does not ring or vibrate when a test call comes in. That way, the test session can proceed without bothering the end user 7 (as illustrated by the “No ringing” label in FIG. 5).

Note that in an alternative embodiment the test call can also be initiated by the DUT 6. For this variation the phone number or the Uniform Resource Indicator of the TS 2 is programmed into the DUT 6. The DUT 6 can then initiate a call to the TS 2 at any convenient time. The TS 2 is programmed to interpret any calls from a DUT 6 as the initiation of a test call.

The DUT 6 stores one or more samples and the test session setup may explicitly specify one of the samples, for example by including the sample file name in a SIP message header or in a message body. The session setup may also implicitly specify a media sample, for example by using the convention that media samples will be used in the order that they were downloaded. In this case the DUT 6 will use the media sample that follows the one that was used in the previous test session, and recommence from the first sample after the last one has been used. If the DUT 6 downloads only a single media sample as illustrated by line 55 in FIG. 5, the session setup implicitly specifies that single sample. We will refer to the specified sample or samples as U_Ri.

When the DUT 6 recognizes the call as belonging to a test session it will play the specified Uplink Reference sample U_Ri over the corresponding uplink connection or uplink bearer as uplink media, as illustrated by line 60. Thus, the setup of a call 56 by the TS 2 and the specification of the sample will cause the DUT 6 to play uplink media corresponding to the specified uplink reference sample over the uplink connection. In case the sample contains both voice and video, the DUT 6 may play the sample over a single uplink multimedia bearer or play it over two uplink bearers; one bearer for voice media and one bearer for video media.

The communication system will automatically route the uplink media to the TS 2, because the TS 2 is the other party in the call. The media may suffer impairments at the DUT 6 or in the communication system link and these impairments may affect the media quality. In any case, the TS 2 will capture the uplink media stream and store it as a Degraded Uplink media sample or uplink degraded sample U_Di as illustrated by box 62 in FIG. 5. The TS 2 may store sample U_Di in volatile RAM, in non-volatile RAM or on disk.

If the Test System has downloaded and specified multiple Uplink Reference samples to be played, the DUT plays each of the specified samples in the order they are specified. The TS 2 will capture each sample as a Degraded Uplink media sample U_Di. In FIG. 5 this corresponds to one or more repetitions of line 60 and of capturing 62.

When the media for the test session have been played, the TS 2 or the DUT 6 end the call in the conventional way as illustrated by line 68. The TS 2 compares the captured sample(s) U_Di with the reference sample(s) U_Ri to estimate the media quality of the uplink as shown by box 72. The TS 2 may use standards-compliant software for the estimation, such as PEQ, POLQA or PEVQ and may express the result of the comparison as a Mean Opinion Score (MOS).

### Test-Call Embodiment for Downlink Link Quality Evaluation

Also as illustrated by FIG. 5, the TS 2 may also initiate a test call to estimate the media quality of the downlink. It sets up the call 56, as described above, and the DUT UE 6 identifies the call as belonging to a test session. The TS 2 proceeds to deliver or play a reference media sample over the downlink connection or downlink bearer to deliver it to the DUT 6. We call this sample D_Rj as shown by line 64. The media may be impaired at the TS 2, in the communication system link, or at the DUT 6. The DUT 6 is programmed to record or capture any downlink media it receives during a test session and to store it as a downlink degraded sample D_Dj. In a variation, the TS 2 may play multiple Downlink Reference samples D_Rj. The DUT 6 will capture each sample as a Degraded Downlink media sample D_Dj. In FIG. 5 this corresponds to one or more repetitions of line 64 and of capturing 66. The DUT 6 is further programmed to upload the recorded downlink degraded sample D_Dj to the TS 2 as illustrated by line 70 using a reliable data connection with the TS 2. The DUT 6 may do this before or after the call has ended. It is possible to upload a recorded sample D_Dj while another sample is being played. The QoS mechanisms in the TS 2, the DUT UE 6 and the system 54 should ensure that the media bearers get a sufficiently high priority over ongoing uploads or downloads, which are typically done with a QoS of ‘Best Effort’.

The TS 2 may play and deliver multiple downlink samples during a single test session and the DUT 6 may be programmed to record all samples and upload them in the order they have been previously downloaded 55 or use another mechanism to specify the individual samples.

The Test System 2 compares the received sample D_Dj with the reference sample D_Rj to estimate the media quality of the downlink as illustrated by box 72. The TS may use software for the estimation, such as PEQ, POLQA or PEVQ and may express the result of the comparison as a Mean Opinion Score (MOS). Link quality estimation may be done before or after the call has been ended. For example, the TS 2 may defer the ending of the call until the uplink quality and/or the downlink quality have been estimated.

### Test System Variations

As shown in FIG. 5, typically the uplink and downlink are tested during the same call. In fact, the DUT 6 and the TS 2 can play/deliver the uplink reference samples and the downlink reference samples at the same time. In FIG. 5, uplink sample playing 60 and downlink sample playing 64 would then overlap in time.

Further, although FIG. 5 does not specifically show that a TS may perform test sessions with a large number of DUTs, such a system figuration can be achieved. The TS may call each of the DUTs in turn, or may call the DUTs according to other rules, as explained below. While a test session with a first DUT is in progress, the TS may call a second DUT and set up a second test session with the second DUT; establish a second uplink connection for the second test session and cause the second DUT to play media corresponding to a reference sample over the second uplink connection. Test sessions with different DUTs may thus overlap entirely or partially. The TS may use the same collection of media samples for all DUTs or may use different samples for different DUTs.

### Minimizing User Impact

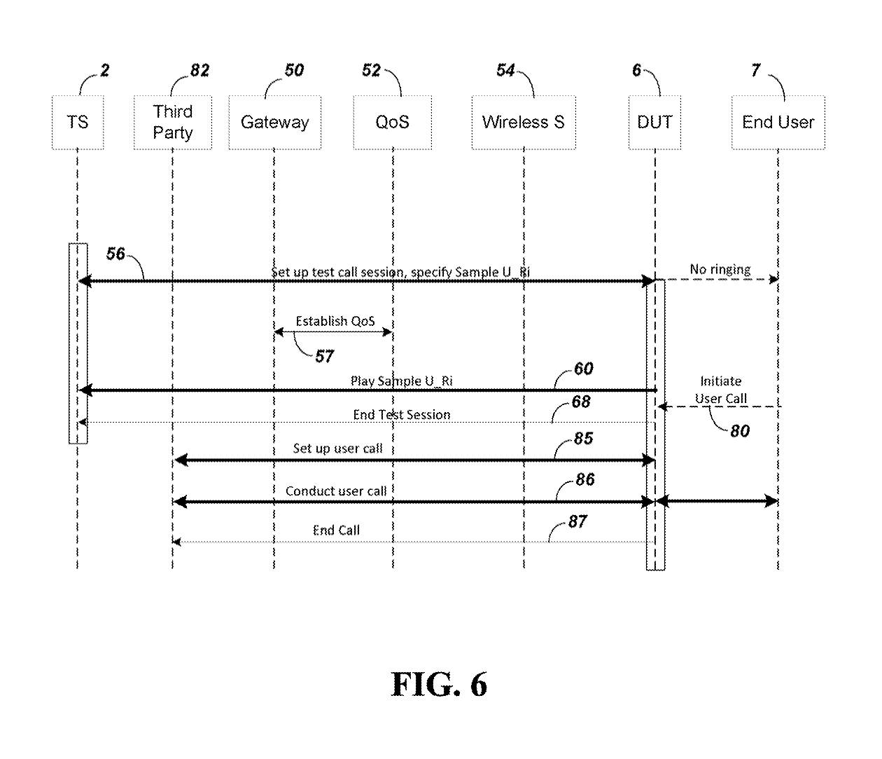

Test calls tend to be short because it may take only 10 or 15 seconds to play or deliver a media sample. To minimize end-user impact in one way, the call duration can be limited by simultaneously playing and delivering the uplink and downlink samples. This limits the impact on the end-user 7. However, there remains a possibility that the end-user 7 initiates or receives a call while a test call is in progress as illustrated in FIG. 6.

Since the DUT does not notify the user at the start of a test call, the end-user typically is not aware that a test call is in progress. As a result, an end user may want to start a non-test call while the DUT is busy in the test call. In this case, the non-test call would fail. Steps to minimize user impact when a non-test call is initiated are illustrated by FIG. 6. FIG. 6 provides a connectivity diagram showing a situation where an end user 7 initiates a user call during a test call. To illustrate set up of the test call, FIG. 6 carries over connectivity lines 56, 60 and 68 from FIG. 5. To proceed further in the diagram of FIG. 6 when the DUT 6 detects that the user initiates a user call during a test call as illustrated by line 80, the DUT 6 interrupts the ongoing test call, for example by hanging up with the TS 2 or by sending a SIP BYE as shown by line 68. Similarly, when the DUT 6 detects that there is an incoming call while a test call is in progress—for example by observing the reception of a SIP INVITE from a peer device such as a third party 82—the DUT 6 can immediately interrupt 68 the test call. The DUT 6 can later reestablish the test call with the TS 2 after the intervening user call has finished, for example by sending an INVITE to the test system. Alternatively the TS 6 can retry the test call after the expiration of a timer. The DUT 2 can further be programmed to reject any test call initiation from the TS 6 that occurs while a call between the user and a third party is in progress.

Once a third party call interrupts a test call, the connectivity between the DUT and a third party continues as illustrated in FIG. 6 after the test call is terminated. As shown by line 85, the third party user call is set up by the DUT for a call initiated by the end user 7 of DUT 6. The third party 82 and DUT 6 then conduct the user call as indicated by line 86. Finally, an end call signal 87 is sent after completion of the call between third party 82 and DUT 6.

### Embodiment as Quality Evaluation Session

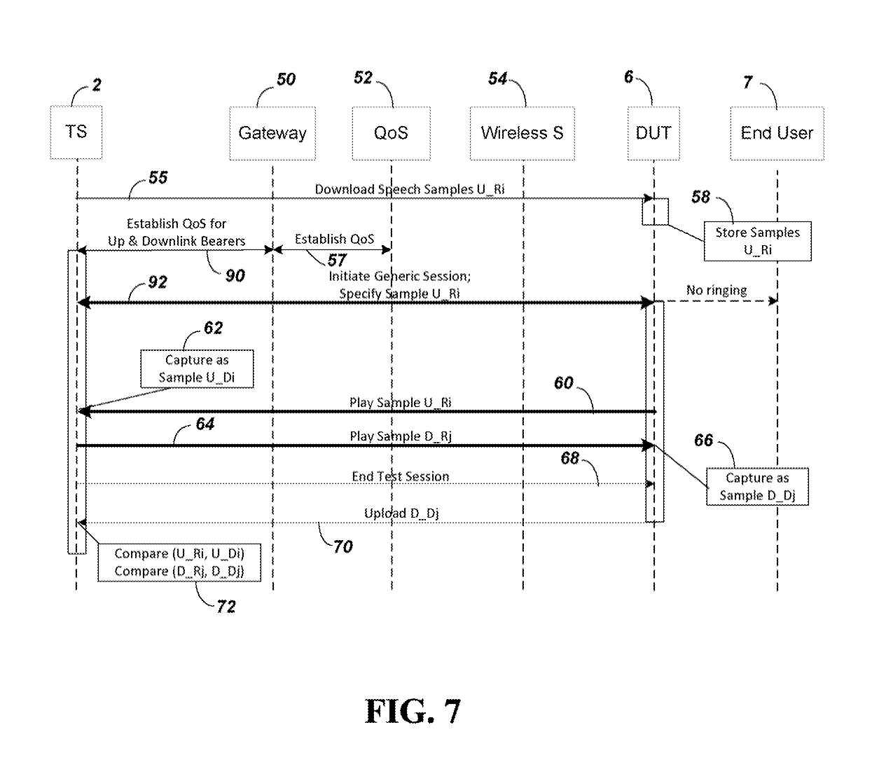

FIG. 7 illustrates an embodiment for evaluation of media quality or QoS on both uplink and downlink. This test system function illustrated in FIG. 7 sets up 92 a generic test session that includes a QoS test, and includes steps carried over from FIG. 5. Note that this generic session is different from a call and does not use the traditional call setup procedures and messages. This implies, for example, that it may be possible to set up and conduct a telephone call while the session is in progress. This will result in two overlapping sessions, the generic session and the session associated with the call. As in the previous embodiments, one or more reference media samples (U_Ri) are transferred or downloaded 55 between the TS and the DUT for uplink testing. Then, the TS 2 or the DUT 6 sets up or initiates 92 the generic test session. The TS or DUT, for example, can send a SIP MESSAGE to inform the DUT or TS that a test session is about to commence. The session initiator may also use another method, such as a text message. Or the initiator may set up an application level session other than a call, using a SIP INVITE. The TS may even use multicast to simultaneously test the downlink media quality of multiple DUTs. The session setup will typically specify to the DUT which sample(s) U_Ri it shall play on the uplink. It does not cause any ringing and does not notify the end-user.

In the embodiment illustrated in FIG. 7, special care is needed to establish uplink and/or downlink bearers that have the correct QoS, namely the QoS that is typical for voice and video calls. The TS can establish such QoS by communicating with the network element in the communication network that controls the QoS, such as the PCRF in the UMTS or LTE wireless system. This is shown by line 90. Depending on how tightly the TS is coupled to the communication system, it may directly communicate with the QoS entity or it may communicate via a proxy. For example, the TS may communicate with a PCRF directly over the Rx interface, or may communicate with the PCRF via a Proxy-CSCF. The P-CSCF could request the QoS, based on information in the SIP MESSAGE or SIP INVITE.

Once the bearer with the correct QoS has been established, the DUT plays 60 the specified Uplink Reference sample(s) U_Ri which are recorded by the TS as the uplink degraded samples (U_Di) 62 and/or the TS plays or delivers 64 the downlink reference sample(s) U_Di and which are recorded by the DUT as the corresponding downlink degraded media samples D_Dj 66. The DUT uploads 70 the recorded sample(s) D_Dj. This may implicitly end the session, or the session may be explicitly ended by the TS or the DUT by sending a message or a BYE 68. The TS must take care that the bearers are released, or the bearers may be automatically released upon expiration of a timer. As before, the TS compares 72 the reference and degraded samples to estimate the media quality of the uplink and/or downlink.

Note that the above description assumes that the TS does all the work to estimate the MOS values (i.e. comparing of samples). This assumption is being made because the estimation software provided by an outside service is expensive. However, it is also possible to let the DUTs do some or all of the comparing if the DUT includes MOS estimation software. The TS would have to download relevant reference and/or degrade samples. A DUT can then communicate the MOS results to the TS (for example in a SIP MESSGE or a text message).

Embodiment with User-Specific Samples

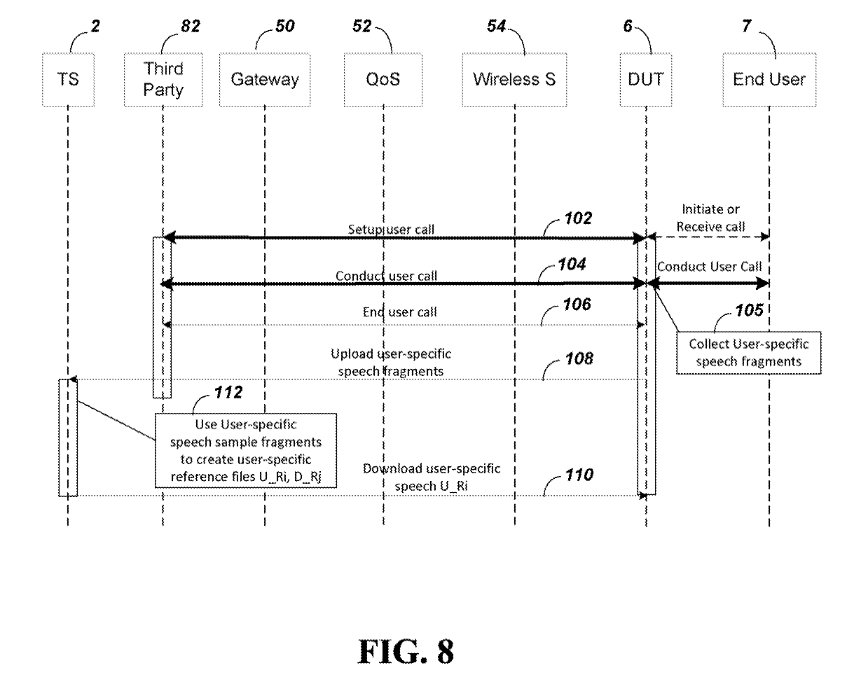

FIG. 8 illustrates an embodiment of the present invention that uses user-specific samples for testing. The embodiments described prior to FIG. 8 have been considered to use generic reference samples such as the reference samples specified for voice testing in ITU T Recommendation P.501. However, the MOS value determined by the TS depends strongly on the sample choice. Therefore it is advantageous to use media samples that are specific to the end-user of the DUT. For example, speech samples should be in the user's language or dialect.

Accordingly, with the embodiment illustrated in FIG. 8, the DUT is programmed to collect media fragments (speech or video) that is spoken or filmed by the end user. During a user call, the DUT may, for example, collect whole talk spurts, whole sentences, or whole words. However, because or privacy considerations, the DUT may be programmed to collect partial words or individual phonemes. This goal is to use these media fragments to construct one or more reference samples that are characteristic for the end-user. The DUT itself may construct the one or more media samples and transfer them between the TS and the DUT, for example by uploading the samples to the TS for later use in a test call or test session. The DUT may also upload the media fragments to the TS and let the TS construct the media sample(s).

FIG. 8 illustrates a user call setup to collect media fragments. The user call, which is a non-test call, is setup as shown by line 102 between the DUT of the user and between the peer device of a third party. The user call is conducted as shown in line 104, with user-specific media fragments or speech fragments collected as shown by box 105. Note that the user-specific media fragments here are fragments that are spoken or sent by the user. Once the user call is ended as illustrated by line 106, the TS 2 uploads the user-specific speech fragments as shown by line 108. The speech fragments are used as illustrated by box 112 to construct or create user specific reference files. The TS 2 will use fragments spoken and sent by the user of the DUT to construct reference samples to test the uplink (U_Ri). In some embodiments, the samples can be collected in the DUT 6 from the TS 2, as illustrated by line 110, to enable the DUT 6 to perform testing steps.

Media samples that are to be used for link quality tests need to have a high Signal to Noise Ratio (SNR). Therefore the DUT 6 may be programmed to collect the media fragments only while it measures a good SNR for the media fragments, for example when the user speaks relatively loudly from a relatively quiet environment, or when the user takes a video under well-lit conditions and with a steady hand.

The TS 2 may use said created user-specific reference samples U_Ri to test the uplink of the user's DUT 6. This makes sense, because this user-specific speech likely will appear on the uplink. In a further variation, the TS 2 learns the identities (e.g. phone numbers of URIs) of third party's UEs 82 with whom the user often communicates. The TS may learn this from the service provider's records, or the TS may obtain such information directly from the DUT, for example, if the DUT is programmed to send such information to the TS 2, e.g. in a SIP MESSAGE. In this variation, the TS checks if it has collected user-specific uplink samples U_Rx from any of the third party UEs 82 and uses such user-specific uplink samples to construct or create downlink reference samples D_Rj to test the downlink quality for DUT 6 (and vice-versa). The use of the third party's user-specific uplink samples U_Rx has the advantage that these samples have been collected by the third party peer devices before they were transmitted over a call connection 104 and should thus have a good fidelity or quality.

In another variation, the DUT is programmed to collect 105 media fragments (speech or video) that is spoken or filmed by the third party in a call and transmitted over the downlink connection of the call 104 from the third party 82 to the DUT 6. As above, the DUT 6 or the TS uses 112 these fragments to construct media reference samples. The TS can then use these samples (D_Rj) to test the downlink of the DUT. The DUT preferably collects the media fragments while there is a high SNR on the downlink connection with the peer device and while there is little background noise in the call. The DUT can thus collect the fragments while there is a good downlink connection for the user call and while the downlink bearer uses a codec with a higher bit rate which provide better quality media.

Embodiment with User-Specified Test Session Timing

While the above variations provide test media that is more relevant to the DUT 6, there is no correlation between the time at which test sessions that take place and the times at which the user of the DUT 6 typically makes calls.

Thus, in one embodiment a variation is provided where the DUT is programmed to initiate a test call with the TS at the end of a user call. When the application in the DUT observes that the user hangs up, or when it observes a SIP BYE, the DUT initiates a test call to the TS to exchange test media samples as described above. This way a tight correlation can be established between the times at which the user makes or receives calls; and the times at which MOS values are estimated. This will automatically also correlate the call locations. (In a variation of this embodiment, the DUT can monitor the locations at which the user makes calls and later initiate test calls with the TS when the DUT returns to those locations.)

The variation of this user specified test session timing may introduce a slight bias. Namely the user may sometimes end a user call because the connection becomes very bad. This bias would increase the number of MOS estimations under less favorable conditions. Some people may argue that that is a desirable bias; others may see it as detrimental.

In one embodiment of the present invention, the above-mentioned bias can be removed. In this variation the DUT is programmed to observe whether the user initiates or receives a user call. When the DUT notices the start of a user call, it sets up 92 a generic test session with the TS. The test session and the user call overlap in time, thereby establishing perfect correlation both in time and in location.

For each of the above embodiments, the system of the present invention will include conventional components to enable the tasks to be accomplished as would be understood by a person of ordinary skill. For example, both the TS and the DUT can include a communication transmit/receive interface, a processor for controlling the communication interface, and a memory for storing software to control the processor, the interface and programming necessary to accomplish steps performed in the present invention.

Although the present invention has been described above with particularity, this was merely to teach one of ordinary skill in the art how to make and use the invention. Many additional modifications will fall within the scope of the invention, as that scope is defined by the following claims.

1. A method to estimate a media link quality for a Device Under Test (DUT), the method comprising:
transferring an uplink reference sample between a Test Station (TS) and the DUT;
establishing an uplink connection between the DUT and the TS;
playing by the DUT uplink media corresponding to the Uplink Reference sample over the uplink connection;
capturing at the TS the uplink media as an uplink degraded sample; and
comparing the uplink reference sample with the uplink degraded sample to estimate the uplink quality.

2. The method of claim 1, further comprising:
establishing a downlink connection between the DUT and the TS;
delivering by the TS downlink media corresponding to a downlink reference sample over the downlink connection;
recording at the DUT the downlink media as a downlink degraded sample;
uploading from the DUT the downlink degraded sample; and
comparing the downlink reference sample with the downlink degraded sample to estimate the downlink quality.

3. The method of claim 1, wherein the transferring an uplink reference sample between the TS and the DUT comprises downloading the uplink reference sample from the TS to the DUT.

4. The method of claim 1, wherein the uplink reference sample comprises audio, video or both audio and video.

5. The method of claim 1, further comprising setting up a session between the DUT and the Test Station (TS) to cause the establishing of the uplink connection between the DUT and the TS and wherein the setting up the session is done without notifying a user of the DUT.

6. The method of claim 5, wherein the setting up the session comprises establishing a voice call.

7. The method of claim 1, wherein the comparing to estimate the uplink quality comprises expressing the uplink quality as a Mean Opinion Score.

8. The method of claim 5, wherein the step of transferring the uplink reference sample comprises transferring at least one additional uplink reference sample; and
wherein the setting up the session comprises specifying the uplink reference sample as the sample to be played.

9. The method of claim 5, wherein the setting up of the session comprises reestablishing a prior session that was interrupted in response to detecting the initiation of a user call during the prior session.

10. The method of claim 1, further comprising:
collecting a plurality of media fragments associated with the DUT;
constructing the uplink reference sample to contain the plurality of media fragments.

11. The method of claim 10, wherein the plurality of media fragments are collected at the DUT.

12. The method of claim 10, wherein the collecting the plurality of media fragments comprises collecting the plurality of media fragments while the DUT measures a favorable Signal to Noise Ratio for the media fragments.

13. The method of claim 2, further comprising:
collecting a plurality of media fragments associated with the DUT;
constructing the Downlink Reference sample to contain the plurality of media fragments.

14. The method of claim 13, wherein the plurality of media fragments are collected from a peer device of the DUT.

15. The method of claim 13, wherein the plurality of media fragments are collected by the DUT during a call with the peer device.

16. The method of claim 15, wherein the collecting the plurality of media fragments from the peer device comprises collecting the plurality of media fragments when the DUT measures a favorable Signal to Noise Ratio for the downlink connection with the peer device.

17. The method of claim 15, wherein the collecting the plurality of media fragments comprises selecting the plurality of media fragments when the DUT determines that the plurality of media fragments are encoded with a high performance codec.

18. The method of claim 1, further comprising:
establishing the uplink connection in response to detecting a termination of a user call.

19. The method of claim 2, further comprising:
establishing the uplink connection in response to detecting an initiation of a user call; and
establishing a Quality of Service for the uplink connection and for the downlink connection during the user call; and
wherein the playing uplink media and the delivering downlink media is concurrent with the user call.

20. The method of claim 5, wherein the session is set up in response to detecting a termination of a user call.

21. The method of claim 1, wherein the TS comprises at least one of a mobile phone, a tablet computer, a personal computer and a laptop computer.

22. A method to estimate a link quality for a Device Under Test (DUT), the method comprising:
establishing a downlink connection between the DUT and a Test Station (TS);
delivering by the TS downlink media corresponding to a downlink reference sample over the downlink connection;
recording at the DUT the downlink media as a downlink degraded sample;
uploading from the DUT the downlink degraded sample; and
comparing the downlink reference sample with the downlink degraded sample to estimate the downlink link quality.

23. The method of claim 22, wherein the transferring an uplink reference sample between a TS and the DUT comprises uploading the uplink reference sample from the DUT to the TS.

24. A testing apparatus to estimate a link quality for a Device Under Test (DUT), comprising:
a test station (TS) including a processor, a memory and a communication interface, the TS processor controlling the communication interface to:
transfer an uplink reference sample between the TS and the DUT;
establish an uplink connection between the DUT and the TS;
cause the DUT to play uplink media corresponding to the uplink reference sample over the uplink connection;
the processor of the TS further to:
capture in the TS memory the uplink media as an uplink degraded sample; and
compare the uplink reference sample with the uplink degraded sample to estimate the uplink link quality.

25. The testing apparatus of claim 24, the processor of the TS further to:
establish a downlink connection between the DUT and the TS;
deliver downlink media corresponding to a downlink reference sample to the DUT over the downlink connection;
upload from the DUT a downlink degraded sample; and
compare the downlink reference sample with the downlink degraded sample to estimate the downlink quality.

26. The testing apparatus of claim 24, wherein the TS comprises an application server for communicating with the DUT.

27. The testing apparatus of claim 24, wherein the processor and communication interface, in combination further:
upload a plurality of media fragments associated with the DUT; and
construct at least one of the uplink reference sample and the downlink reference sample to contain the plurality of media fragments.

28. The testing apparatus of claim 24, wherein the TS is provisioned for at least one uplink reference sample for communicating the uplink reference sample to the DUT, wherein the uplink reference sample may be a voice sample, a video sample, or a sample that contains a combination of voice and video.

29. The testing apparatus of claim 24 wherein the processor and communication interface, in combination further:
set up a test-session with the DUT;
establish the uplink connection as the uplink connection for the test session with the DUT;
while the test-session with the DUT is in progress, set up an other test-session with an other DUT;
establish an other uplink connection as the uplink connection for the other test session with the other DUT; and
cause the other DUT to play uplink media corresponding to a reference sample over the other uplink connection.
